(19) United States
(12) Patent Application Publication
(10) Pub. No.: US 2026/0319670 A1
(43) Pub. Date: Oct. 15, 2026

(54) CONTINUOUS DROPPED WRITE AND CORRUPTION DETECTION IN DISK DRIVES

(71) Applicant: International Business Machines Corporation, Armonk, NY (US)

(72) Inventors: Roderick Guy Charles Moore, Bournemouth (GB); FLORENT CHRISTIAN ROSTAGNI, Eastleigh (GB); Paul Nicholas Cashman, Burnham-on-Sea (GB); Lee Jason Sanders, Chichester (GB)

(21) Appl. No.: 19/214,251

(22) Filed: May 21, 2025

(30) Foreign Application Priority Data
Apr. 9, 2025 (GB) 2505308.3

(51) Int. Cl. G06F 3/06

(52) U.S. Cl. CPC G06F 3/0619; G06F 3/0659; G06F 3/0689

(57) ABSTRACT

A computer-implemented method for managing a storage system is provided. The computer-implemented method includes calculating a source validation check for a set of storage blocks sent from a source device to a target storage device. The computer-implemented method further includes determining, after the set of storage blocks are written to the target storage device, a sum validation check for the set of storage blocks written to the target storage device. The computer-implemented method further includes comparing the source validation check to the sum validation check. The computer-implemented method further includes implementing an error recovery procedure on the storage system in response to the source validation check differing from the sum validation check.

### BACKGROUND

The present invention is generally directed to storage. In particular, the present invention is directed to a method, computer program product, and computer system for managing a storage system.

Disks, also known as ‘disk drives’, or simply ‘drives’, are storage devices. Many computer systems use a redundant array of independent disks (RAID) for data storage purposes. This allows for improved data transfer rates over a single disk access, and also provides error correction, data protection and disk redundancy.

RAID systems are disk array storage systems created to provide large storage areas, fast access times and rates, and also redundancy for data protection. For example, data can be mirrored across two or more disks, so if one disk fails, the data is available from the remaining disks. Alternatively, data can be spread over multiple disks allowing concurrent reading of data. Data parity can also be provided in a further disk, so if one disk fails, data can be recreated from the remaining disks. RAID systems are controlled by a RAID controller, which is a hardware unit that configures a RAID array and provides a RAID layer, so that to a computer system, a disk array appears as a logical, single disk.

Most modern storage controllers will use a RAID algorithm to spread data across multiple disks to add redundancy and to prevent data loss on a disk failure. Advanced copy services are also available. Advanced copy services copy data from one disk to another for a variety of purposes, for example, backup.

### SUMMARY

According to one embodiment of present invention, a computer-implemented method for managing a storage system is provided. The computer-implemented method includes: calculating a source validation check for a set of storage blocks sent from a source device to a target storage device; determining, after the set of storage blocks are written to the target storage device, a sum validation check for the set of storage blocks written to the target storage device; comparing the source validation check to the sum validation check; and implementing an error recovery procedure on the storage system in response to the source validation check differing from the sum validation check.

According to another embodiment of the present invention, a computer program product for managing a storage system is provided. The computer program product includes one or more computer-readable storage media, and program instructions stored on the one or more computer-readable storage media to perform operations including: calculating a source validation check for a set of storage blocks sent from a source device to a target storage device; determining, after the set of storage blocks are written to the target storage device, a sum validation check for the set of storage blocks written to the target storage device; comparing the source validation check to the sum validation check; and implementing an error recovery procedure on the storage system in response to the source validation check differing from the sum validation check.

According to yet another embodiment of the present invention, a computer system for managing a storage system is provided. The computer system includes a processor set, one or more computer-readable storage media, and program instructions stored on the one or more computer-readable storage media to cause the processor set to perform operations including: calculating a source validation check for a set of storage blocks sent from a source device to a target storage device; determining, after the set of storage blocks are written to the target storage device, a sum validation check for the set of storage blocks written to the target storage device; comparing the source validation check to the sum validation check; and implementing an error recovery procedure on the storage system in response to the source validation check differing from the sum validation check.

### BRIEF DESCRIPTION OF THE DRAWINGS

The present invention will now be described, by way of example only, with reference to preferred embodiments, as illustrated in the following figures.

FIG. 1 depicts a computing environment 100, according to an embodiment of the present invention.

FIG. 2 depicts a high-level exemplary schematic flow diagram depicting operation method steps 201 for managing a storage device, according to an embodiment of the present invention.

FIG. 3 depicts a high-level exemplary schematic diagram 300 depicting functional components, according to an embodiment of the present invention.

FIG. 4 depicts a high-level exemplary schematic diagram 400 depicting a computer system, according to an embodiment of the present invention.

FIG. 5 depicts a table 500 used to store checksums, according to a preferred embodiment of the present invention.

### DETAILED DESCRIPTION

The present invention is generally directed to storage. In particular, the present invention is directed to a method, computer program product, and computer system for managing a storage system.

Some modern disks, such as IBM ® FlashCore Modules (FCM), implement internal, hardware-based compression algorithms. It is not unrealistic for a disk to support more than one algorithm at the same time, choosing which one to use for a certain write based on internal logic. The different compression algorithms will have different characteristics of compressibility and speed of compression. The higher the compression ratio the longer the disk takes to compress. Different compression algorithms can be used for different copies of the same data, so that on reading that data an appropriate copy can be used matching specified performance characteristics. However, this can lead to an unbalanced systems in terms of performance.

Once a host/controller has written data and received successful completion from a disk drive, it is impossible to confirm if the data is truly preserved on the disk drive without rereading the data.

Methods exist to reread data periodically, such as RAID parity scrub that validates the data in the RAID array at a given point in time. However, such mechanisms do not detect dropped writes or corruption at the point of failure but rather will detect issues much later once the background mechanism fires. It may also miss dropped writes that were overwritten before the next scrub which may self-heal the data or with promoted full stride writes may lead to bad data but matching parity preventing the detection of inconsistency by the Raid scrub.

When corruption is detected, it is not always clear if the issue is a write that was never sent to a drive, never received by the drive or dropped by the drive. Therefore, it is difficult to know if the fault is with the sending controller of the receiving disk drive.

Therefore, there is a need in the art to address the aforementioned problems.

According to various embodiments of the present invention, a computer-implemented method, a computer program product, and a computer system for managing a storage system are provided. A source validation check is calculated for a set of storage blocks sent from a source device to a target storage device. A sum validation check is determined for the set of storage blocks written to the target storage device. In an embodiment, the sum validation check is determined after the set of storage blocks are written to the target storage device. The source validation check is then compared to the sum validation check. An error recovery procedure is implemented on the storage system in response to the source validation check differing from the sum validation check.

In an embodiment of the present invention, the source validation check is calculated in response to determining that a threshold data transfer size for the set of storage blocks sent from the source device to the target storage device has been reached. In an embodiment, a count of the data size of the set of storage blocks transferred from the source device to the target storage device is maintained.

In an embodiment of the present invention, a block validation check is determined for each block of the set of storage blocks written to the target storage device, and the sum validation check is determined based on the block validation checks for the set of storage blocks written to the target storage device.

In an embodiment of the present invention, implementing the error recovery procedure on the storage system includes reading the set of storage blocks to determine if the sum validation check is valid, and reporting a failure to the source device in response to determining that the sum validation check is invalid.

In an embodiment of the present invention, the source device is a storage controller, and the target storage device is a storage disk.

In an embodiment of the present invention, the target storage device is a virtual disk. In an embodiment of the present invention, the virtual disk includes a RAID array.

In an embodiment of the present invention, the error recovery procedure on the storage system includes a RAID rebuild.

In an embodiment of the present invention, the source device is a storage device, and the target storage device is a copy of data written to the source device. In an embodiment of the present invention, the copy of the data written to the source device is selected from the group consisting of: a point-in-time copy, a synchronous remote copy, and an asynchronous remote copy.

In an embodiment of the present invention, the source validation check and the sum validation check are selected from the group consisting of: a longitudinal redundancy check (LRC), a cyclic redundancy check (CRC), and cryptographic hash functions.

Advantageously, the present invention provides a running data validation check for the last N GBs of data written by the controller to an individual storage device (e.g. disk) in order to identify if and where in the system the write has been dropped/corrupted or misdirected. This validation check is maintained for each disk independently and is passed to the disk at the end of the N GBs of data being written. The disk will also maintain the running data validation check of the same last received N GBs of data and validate that the incoming data validation check matches its running validation check. The disk can also validate that each individual write of the last N GBs of data passes its validation by rereading the data from the media and making sure it matches its own internal running validation checks. Any failure to validate the data can result in the disk reporting a failure to the controller. It should be appreciated that the term disk applies to any storage device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the present invention may be practiced with steps in a different order, and/or with hardware elements in configurations that are different than those which are disclosed. Therefore, although the present invention has been described based upon these preferred embodiments, it would be apparent to those of skill in the art that certain modifications, variations, and alternative constructions would be apparent.

While preferred embodiments of the present application have been described, it is to be understood that the embodiments of the present invention described are illustrative only and the scope of the present invention is to be defined solely by the appended claims when considered with a full range of equivalents and modifications (e.g., protocols, hardware devices, software platforms etc.) thereto.

Moreover, the same or similar reference numbers are used throughout the drawings to denote the same or similar features, elements, or structures, and thus, a detailed explanation of the same or similar features, elements, or structures will not be repeated for each of the drawings. The terms "about" or "substantially" as used herein with regard to thicknesses, widths, percentages, ranges, etc., are meant to denote being close or approximate to, but not exactly. For example, the term "about" or "substantially" as used herein implies that a small margin of error is present. Further, the terms "vertical" or "vertical direction" or "vertical height" as used herein denote a Z-direction of the Cartesian coordinates shown in the drawings, and the terms "horizontal," or "horizontal direction," or "lateral direction" as used herein denote an X-direction and/or Y-direction of the Cartesian coordinates shown in the drawings.

Additionally, the term “illustrative” is used herein to mean “serving as an example, instance or illustration.” Any embodiment or design described herein is intended to be “illustrative” and is not necessarily to be construed as preferred or advantageous over other embodiments or designs.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

For the avoidance of doubt, the term “comprising”, as used herein throughout the description and claims is not to be construed as meaning “consisting only of”.

To illustrate the invention, a disk will be used as an example of a storage device. One having ordinary skill in the art will understand that the invention is equally applicable to any type of storage device.

A logical unit number (LUN) is a unique identifier for identifying a collection of physical or logical storage. A LUN can reference a single disk, a partition of disks, or an entire RAID array. Logical block addressing (LBA) is a method for specifying a location of blocks of data on storage devices.

Small Computer System Interface (SCSI) is a set of command set standards for physically connecting and transferring data between computers and peripheral devices, such as disks. One having ordinary skill in the art will understand that there are other command sets. SCSI is available in a number of interfaces, for example, SSA, 1 Gbit Fibre Channel (1GFC), SAS. SCSI can be parallel or serial.

In the storage subsystems of IBM® DS8000® series, IBM Storwize®, and IBM FlashSystem, the SAS protocol is used for the internal disks. The storage subsystems have controllers that provide the required hardware adapters for host connectivity to the subsystem. RAID adapters are used to create a virtual disk or logical unit number (LUN) that is configured in one of the supported RAID levels with multiple SAS hard disks based on the level of RAID used. Various levels of RAID of available to configure internal SAS HDDs or SDDs. IBM, DS8000, Storwize and FlashCopy are trademarks of International Business Machines Corporation, registered in many jurisdictions worldwide.

There are a number of RAID architectures depending on the required balance between fault tolerance and performance. These architectures are known as ‘levels’. In RAID level 0, data blocks are striped across a disk array without any faut tolerance. In RAID level 1, data is mirrored across two disks. In RAID level 5, data blocks are striped across the disks and on one disk a parity checksum of all the block data is written. The parity data is not written to a fixed disk but rather is spread across all disks. If a disk fails, data can be recovered using the remaining block data and the block. In RAID level 6, data blocks and also dual parities are striped across the disks. RAID 6 can handle dual disk failures.

On each physical disk data is stored in predefined blocks of data generally having the same size. A predefined number of blocks of data, and any appropriate parity information are mapped to define a stripe of data, which is distributed across the elements of the RAID array. A typical stripe size is 8k to 64k bytes. A “stripe” is made up of a group of corresponding stripe units (also known as “strip size”). The stripe size depends on workload. Larger strip sizes favor sequential workloads, while smaller strip sizes favor random I/O performance.

Common RAID levels are:
RAID 0 - Data striped across one or more disks, no redundancy;
RAID 1 - Data is mirrored between two disks;
RAID 5 - Data is striped across a minimum of three disks with one rotating parity;
RAID 6 - Data is striped across a minimum of five disks with two rotating parities; and
RAID 10 - Data is striped across pairs of mirrored disks, with a minimum of two disks

RAID arrays can be configured using a hardware adapter. This is termed ‘hardware RAID’. RAID arrays can also be configured using operating system software. This is termed ‘software RAID’.

In storage systems, data can be lost if a disk that the data is stored on fails. With fault tolerant RAID levels, for example, RAID 1, RAID 5 and RAID 6, such data can be recovered from remaining disks and re-written to a repaired disk or to a spare disk. The array is said to be “rebuilt”. In a RAID 1 write, a storage block is written to two disks at the same time.

A RAID controller, or ‘disk array controller’ is a device that manages the physical disks and presents them to the computer as logical units. The RAID controller has a front-end interface to a computer system’s host adapter. An example of an interface is SCSI. The RAID controller also has a back-end interface for communicating with underlying disks. RAID controllers carry out numerous functions in addition to RAID management and I/O functionality. Examples are controller failover and array copy services.

JBOD (Just a Bunch of Disks) is another architecture that uses an array of multiple disks. These can be made available to the overlying system as a set of independent disks, or as a spanned single volume without RAID technology.

In a storage system there are many levels of abstraction. A storage disk manages physical placement of data blocks onto the disk media. Built-in functionality handles data block placement. For example, a drive can identify media errors, and can therefore relocate blocks to appropriate media positions while still presenting a logical contiguous block space to an upstream storage controller.

To illustrate embodiments of the present invention, a data validation threshold of 1GB is used, but other sizes may be used, or the data validation threshold may be a sum over a specific number (N) of writes (e.g., 1000 writes) of any size.

In an embodiment of the present invention, a single target disk can be used to implement the invention. The disk itself may be a virtualised disk on another system, but for simplicity purposes, the disk is treated as a single entity by the system implementing the invention.

A Longitudinal Redundancy Check (LRC) is an error detection method commonly used in data transmission and storage. LRC operates on groups of bytes organized as rows in a table. A parity bit is appended to each row of data. LRC is better than using a single parity bit, as it can detect an odd number of errors within a row. However, LRC cannot identify the exact location of an error or correct it. LRC is similar to a checksum or cyclic redundancy check (CRC) and can be combined with other error-control methods for more robust error detection and correction.

One having ordinary skill in the art will understand that other error detection and correction methods can be used, such as CRC and cryptographic hash functions (e.g., MD5, SHA1).

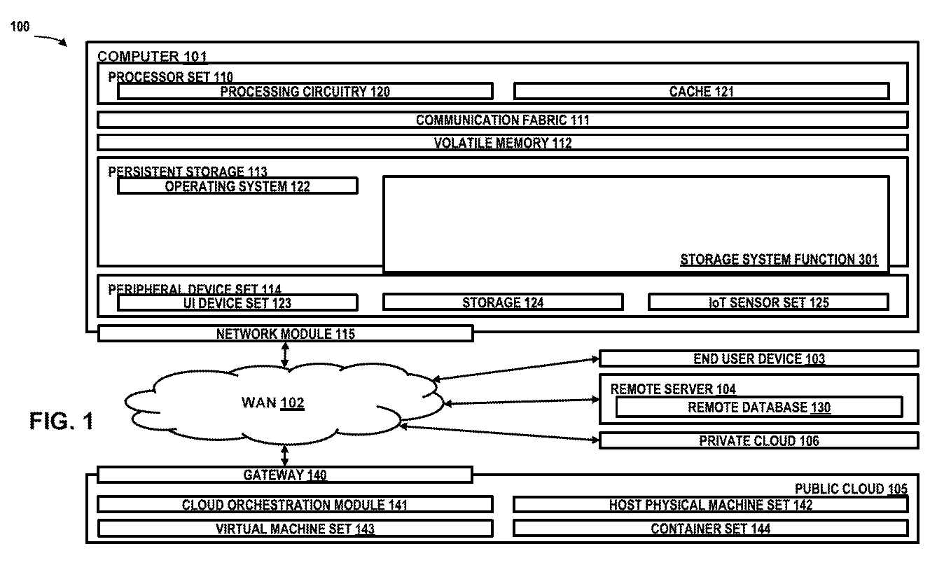

FIG. 1 depicts a computing environment 100. Computing environment 100 contains an example of an environment for the execution of at least some of the computer code involved in performing the inventive methods, such as storage system function 301. In addition to storage system function 301, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and storage system function 301, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in storage system function 301 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in storage system function 301 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard disk, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

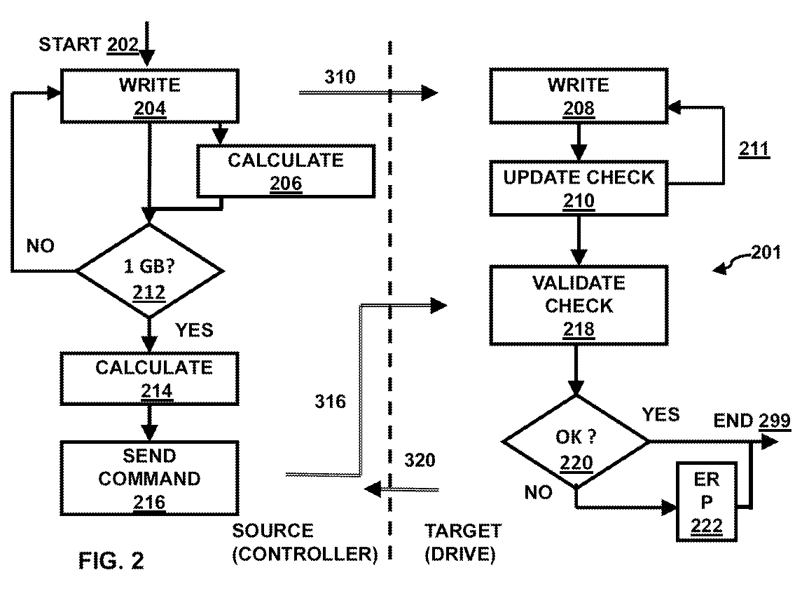

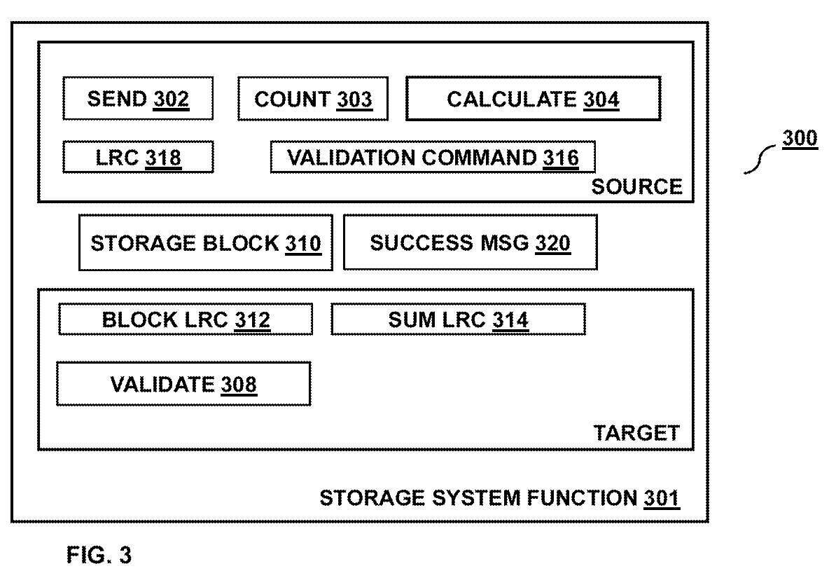

FIG. 2, which should be read in conjunction with FIGS. 3 to 5, depicts a high-level exemplary schematic flow diagram depicting operation methods steps 201 for managing a storage device, according to an embodiment of the present invention.

FIG. 3 depicts a high-level exemplary schematic diagram 300 depicting functional components, according to an embodiment of the present invention.

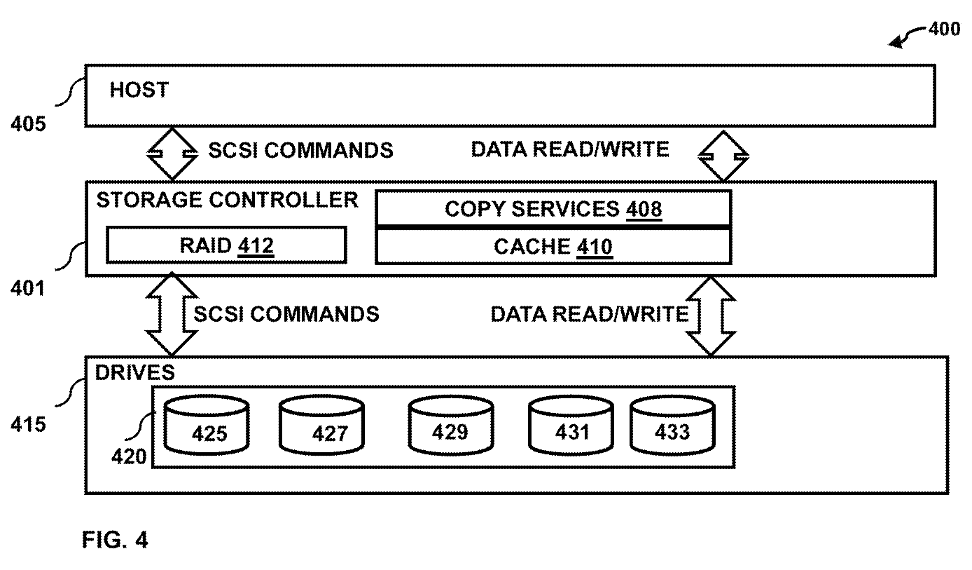

FIG. 4 depicts a high-level exemplary schematic diagram 400 depicting a computer system, according to an embodiment of the present invention. FIG. 4 depicts a host 405, a storage controller, which has RAID controller functionality 412, a disk enclosure 415, and a disk 420. The storage controller 401 also comprises a stack of components, for example a copy services component 408, and a cache 410. The disk 420 may be a virtual disk. For example, the virtual disk may be a RAID array comprising the five storage disks 425, 427, 429, 431, 433. Commands are passed between the host 405, storage controller 401 and disk enclosure 415 using SCSI commands. If a cache 410 is available, data is written to the cache 410 and destaged to the disks according to a cache algorithm. For reads, data is first read from the cache 410, and only if not present (known as a cache miss), the data is read from the disks. Data is read and written across the depicted interfaces.

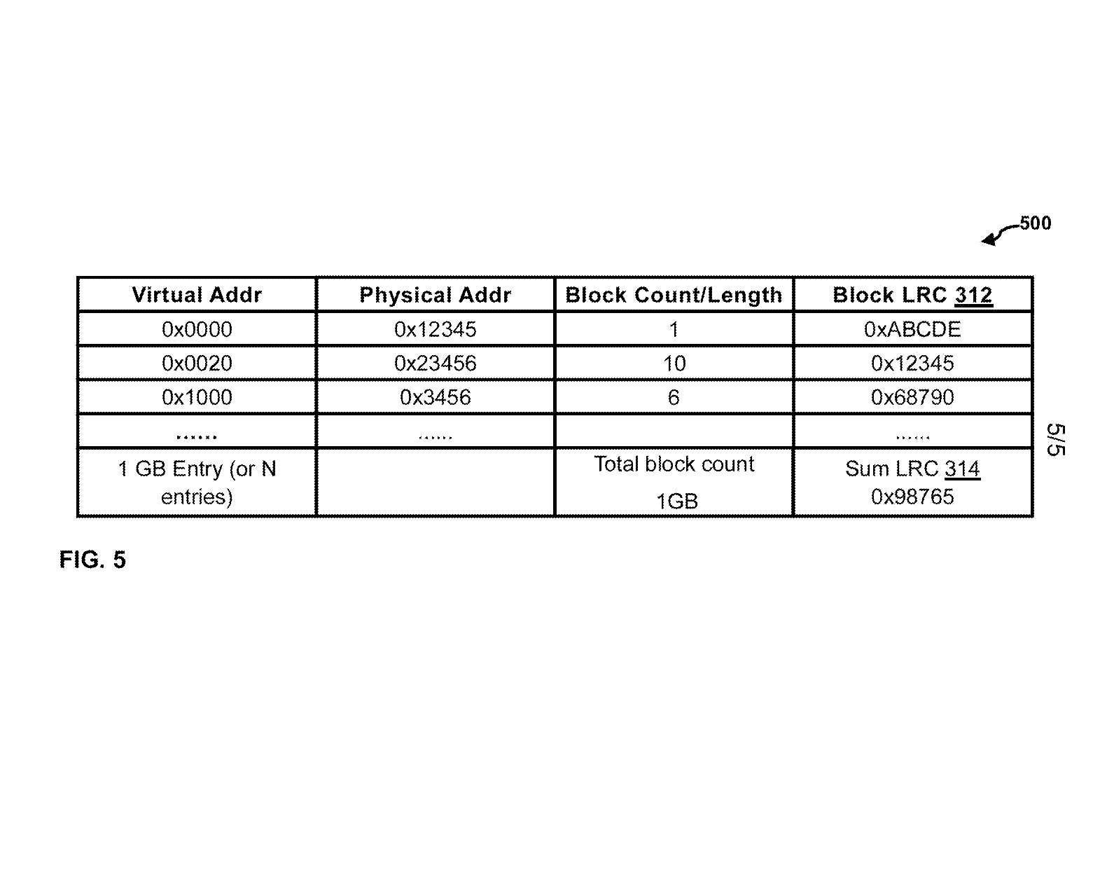

FIG. 5 depicts a table 500 used to store checksums, according to an embodiment of the present invention.

To illustrate embodiments of the present invention, LRC will be used as a validation check, but this does not limit this disclosure to only the LRC method of data validation. The storage controller 401 has a single running LRC check for each disk 420 in the system. This validation could be for example, but not limited to, a checksum/LRC or hash or using the first byte of the data sent. Anyone that is familiar with the current state of the art will be aware that each validation mechanism has obvious advantages/disadvantages such as false negatives, but could be used if performance was a concern.

The method starts at step 202. In an embodiment, a storage controller 401 acting as a source writes a storage block 310 to a disk 420 acting as a target. One having ordinary skill in the art will understand that the present invention is also applicable to other examples of sources and targets, for example, peer to peer copying where one storage device acts as a source and another storage device acts as a target.

At step 204, a send component 302 of the storage controller 401 ‘writes’ a storage block 310 to the disk 420. In ‘writing’ the send component 302 sends the storage block 310 to the disk 420 for the disk electronics to write onto the media of the disk 420. As used herein, the term “storage block” 310 will refer to a block of data to be written to or read from a disk 420. The size of a storage block 310 is set by the host 405, but common sizes are 4kB, 8kB, 16kB, 32kB, 64kB, 128kB and 256kB. Sizes 32kB – 256kB are typical. A running count 303 tracks the amount of data that has been sent, including the amount of data sent since the data validation threshold was last reached.

At step 208, the disk 420 writes the storage block 310 on the disk media. At step 210, the disk calculates a block LRC 312 for the storage block 310. Modern CPUs from companies such as Intel, AMD, ARM etc. now contain specialist instructions to calculate LRC on data on the fly which significantly reduces the cost of calculating the checksums of the data. This is performed as modern CPUs have high clock speeds, specialized instructions, parallel processing, hardware acceleration and optimized algorithms. The basic LRC calculation is relatively simple, involving XOR operations on a succession of data words. Additionally, modern flash drives contain Field Programmable Gate Arrays (FPGAs) that will perform similar tasks, so generation of the LRC (or some other checksum scheme) is almost zero cost to performance.

Steps 208 and 210 are repeated 211 as more storage blocks 310 are written by the storage controller 401. The disk 420 stores the block LRCs 312 for each individual storage block 310 written by the disk 420. The disk 420 keeps a block LRC 312 for each received storage block 310 and a sum/XOR’d LRC 314 of all received writes to validate what is passed from the storage controller 401 in a validation command 316. The disk 420 also keeps a running total of the amount of data written. The disk 420 can expect a validation command 316 after 1GB of data has been written.

At step 212 the storage controller 401 determines whether the data validation threshold of 1GB of data has been written by referring to the running count 303. If ‘No’, the method returns to step 204.

If ‘Yes’, at step 214, a controller calculate component 304 calculates a controller LRC 318 for the latest 1GB of data. At step 216, the storage controller 401 sends the validation command 316 to the disk 420 including the controller LRC 318. The storage controller 401 expects to receive a success/failure message 320 depending on the drive’s validation checks to signal completion.

At step 218, the disk 420 receives the validation command 316 and the controller LRC 318 for the latest 1GB of data. A disk validation component 308 compares the controller LRC 318 with that of the sum LRC 314 for validation purposes. The disk 420 can also validate that the actual data on the media matches the individual block LRCs 312 for each individual write that it received that made up the 1GB total validation unit. The table 500 of FIG. 5 depicts example data stored by the disk to enable this validation.

At step 220, if the disk validation component 308 determines that the sum LRC 314 is the same as the controller LRC 318, the method ends at step 299.

At step 220, if the disk validation component 308 determines that the sum LRC 314 is not the same as the controller LRC 318, at step 222, the disk 420 implements an error recovery procedure (ERP). In the ERP the disk 420 can report that there is a mismatch between the storage blocks 310 sent by the storage controller 401, and any storage blocks 310 that the disk 420 received, or what is stored on the medium. If the LRCs 314, 318 were to pass the check validation at step 218, but the individual write validation fails, the disk 420 can report that the mismatch is on what the disk has written to media. This would provoke the storage controller 401 to rewrite the storage blocks 310 for the dropped/missing data. If the disk 420 has not received 1GB of data, but has received the validation command 316, the disk 420 reports this directly and the storage controller 401 then rewrites the affected data. Conversely, if the disk 420 has not received a validation command 316 after receiving 1GB of data, the disk 420 can return a soft warning (e.g., KCQ) that indicates a missing validation check.

The disk 420 sends a success/failure message 320 to the storage controller 401. If the storage controller 401 does not receive a success/failure message 320 before a timeout period, the storage controller 401 raises an error alert.

At step 299, the method ends.

Modern flash-based disks 420 do not overwrite in place. Instead, such disks 420 use a log structured array and always write to a new physical location. Old data is left to be cleared by a garbage collection algorithm. This means that each write to a disk 420 can persist at its physical location even if the logical address has been overwritten. This allows the disk 420 to keep a block LRC 312 for each received write, and this data can be validated even if the logical address has been overwritten.

In an alternative embodiment, at step 206, the controller calculate component 304 calculates a controller LRC 318 for the storage block 310. The controller LRC 318 is stored for each storage block 310.

In an alternative embodiment, the storage controller 401 stores historic controller LRCs 318 for later debug requirements.

In an alternative embodiment, to enable the disk 420 to have time to validate the data associated with the current controller LRC 318 passed from the storage controller 401 and still be available for new inbound writes, the disk 420 implements more than one table of inbound writes with their associated physical data locations. In an alternative embodiment, validation data block LRC 312 and sum LRC 314 are maintained with a ring buffer of sufficient size to ensure that the validation can be processed before the data is overwritten by new writes. If the individual Input/Output (I/O) validation performance is not able to keep up with the inbound writes, the sum LRC 314 can be used alone as a fallback and the block LRCs 312 checks could be restarted as performance allows. Other options are available and these are only given as example implementations.

In an alternative embodiment, the disk 420 is a virtual disk that comprises of a RAID array of storage disks 425, 427, 429, 431, 433. In this alternative embodiment, a write from source to target disk 420 follows operation method steps 201 described above. However, at a lower level, a write to a virtual disk, such as disk 420 in this instance, is in reality a write from a virtual disk to its underlying storage disks 425, 427, 429, 431, 433. In the case of a 4+P RAID 5 array, for example, a storage block comprising a stripe of 128kB is distributed across 4 underlying storage disks 425, 427, 429, 431. 32kB is written to each underlying storage disk 425, 427, 429, 431, and a 32kB parity block is written to parity storage disk, such as storage disk 433. The operation method steps 201 may be applied to each of the storage disks 425, 427, 429, 431, 433 to validate that the correct data has been written.

In this alternative embodiment, at step 222, identification of a write error leads to the storage controller 401 to force a RAID rebuild of the data to rewrite the dropped/missing data.

Embodiments of the present invention also apply to copy function technologies, for example, point-in-time copy functions to create snapshot and clone copies, asynchronous remote copy and synchronous remote copy. An example of a point-in-time offering is IBM Flashcopy®. In these cases, the presentation invention applies to a source disk copying to a target disk.

IBM Remote mirror and copy is a storage feature that constantly updates a target copy of a volume so that it matches changes that were made to its associated source volume. IBM Remote mirror and copy does not capture the state of the source volume at some point in time but rather reflects all changes that were made on the source volume to the target volume.

IBM Global Copy provides an asynchronous long-distance copy option where write operations to a storage unit at a production site are considered complete before they are transmitted to a storage unit at a recovery site. IBM Metro Mirror functions provide a synchronous long-distance copy option that constantly updates a secondary copy of a volume to match changes made to a source volume. Writes to the production site are only considered complete when transmitted to a storage unit at a recovery site.

Point-in-time copy is a feature supported on various storage devices that allows nearly instantaneous point-in-time copies of entire logical volumes or data sets to be made. The point-in- time function allows full volume copies of data to be made, with the copies immediately available for read or write access. The copy may be used with standard backup tools that are available in a computing environment to create backup copies on tape.

“Snapshot” provides the ability to record the state of a storage device at any given moment and preserve that snapshot as a guide for restoring the storage device in the event that it fails. A snapshot primarily creates a point-in-time copy of the data. Typically, a snapshot copy function is done instantly and made available for use by other applications such as data protection, data analysis and reporting and data replication applications. The original copy of the data continues to be available to the applications without interruption, while the snapshot copy is used to perform other functions on the data. A snapshot is a point-in-time copy that is dependent on the primary disk. A snapshot may, for example, be accomplished using a copy-on-write procedure, in which currently existing data in a region on the primary disk is written to the backup disk when a write is being made to the region on the primary disk. Thus, the backup disk will contain data that has been overwritten on the primary disk, as opposed to a complete copy of the primary disk. This type of backup copy typically results in a thinly provisioned volume, which reduces storage. A series of snapshot copies may be cascaded together to represent the primary disk at various times. However, the snapshot copies typically remain dependent on the primary disk to reassemble a complete copy of the primary disk. Therefore, a snapshot is a point-in-time copy where the target only holds the changed data necessary to present the point-in-time copy of the source. Data is only copied to the target disk if it is changed on the source. The target disk is generally always dependent on some of the data on the source disk in order to present the point-in-time copy.

In contrast, a " clone” is a point-in-time copy that is independent of the primary disk. A clone may, for instance, be created by executing a background copy procedure in which a disk's regions are sequentially copied to the backup disk and executing a copy-on-write procedure to immediately copy any primary disk regions that are about to be overwritten due to a write and have not yet been processed by the background copy procedure. A clone is typically used when a copy is needed and input/output (I/O) to the copy must not impact I/O to the primary volume in any way. A clone may also be used when the copy is not to be affected by availability to the source. A clone may also be used in a cascade. Therefore, a clone is a point-in-time copy where the target disk will hold a complete copy of the data that was on the source disk when the point-in-time copy was started. When the copying of the data from source to target completes, the target disk is independent of the source.

Point-in-time copies are made using a bitmap to keep track of data grains copied over from a source disk to a target disk. When data is copied between a source and a target, the data is copied in chunks known as “grains.” Grain size is determined at the time of mapping creation. Typical sizes are 256KB and 64KB. Data grains are copied using a background copy process. In the event of a read of a data grain to the target drive before the data grain has been copied over to the target, the read is redirected to the source drive. In the event of a read of a data grain to the target drive after the data grain has been copied over to the target, the read is directed to the target drive. In the event of a write of a data grain to the target drive before the data grain has been copied over to the target, the corresponding entry in the bitmap is marked as complete. In the event of a write of a data grain to the target drive after the data grain has been copied over to the target, the write is directed to the target drive. In the event of a write of a data grain to the source drive before the data grain has been copied over to the target, the data grain is first copied to the target drive before the source disk data grain is overwritten with new data. In this way the source and target drives are presented to the host as being instantaneously available, even before all data has actually been copied over to the target drive.

As referred to above, in a RAID 1 write, a storage block is written to two disks at the same time. In contrast, in a remote copy an existing storage block is copied from a source to a target, equivalent to performing a read from the source, and a write to the target.

In an alternative embodiment, the source and target may reside within the storage controller 401. For example, writes to the cache 410 can be validated by considering the cache 410 as the target from source writes from the host 405.

In an alternative embodiment, the present invention may be applied to reads from a drive. The drive acts as a source, and the storage controller 401 acts as the target. This embodiment is useful to check that data has been successfully read from a disk, for example, in the case that a network is suspected of failure.

What is claimed is:

1. A computer-implemented method for managing a storage system, comprising:
calculating a source validation check for a set of storage blocks sent from a source device to a target storage device;
determining, after the set of storage blocks are written to the target storage device, a sum validation check for the set of storage blocks written to the target storage device;
comparing the source validation check to the sum validation check; and
responsive to the source validation check differing from the sum validation check, implementing an error recovery procedure on the storage system.

2. The computer-implemented method of claim 1, wherein the source validation check is calculated in response to determining that a threshold data transfer size for the set of storage blocks sent from the source device to the target storage device has been reached.

3. The computer-implemented method of claim 1, further comprising:
determining a block validation check for each block of the set of storage blocks written to the target storage device,
wherein the sum validation check is based on the block validation checks for the set of storage blocks written to the target storage device.

4. The computer-implemented method of claim 1, wherein implementing the error recovery procedure on the storage system includes:
reading the set of storage blocks to determine if the sum validation check is valid; and
responsive to determining that the sum validation check is invalid, reporting a failure to the source device.

5. The computer-implemented method of claim 1, wherein the source device is a storage controller, and the target storage device is a storage disk.

6. The computer-implemented method of claim 1, wherein the target storage device is a virtual disk.

7. The computer-implemented method of claim 6, wherein the virtual disk includes a RAID array.

8. The computer-implemented method of claim 1, wherein the error recovery procedure on the storage system includes a redundant array of independent disks (RAID) rebuild.

9. The computer-implemented method of claim 1, wherein the source device is a storage device, and the target storage device is a copy of data written to the source device.

10. The computer-implemented method of claim 9, wherein the copy of the data written to the source device is selected from the group consisting of: a point-in-time copy, a synchronous remote copy, and an asynchronous remote copy.

11. The computer-implemented method of claim 1, wherein the source validation check and the sum validation check are selected from the group consisting of: a longitudinal redundancy check (LRC), a cyclic redundancy check (CRC), and cryptographic hash functions.

12. A computer program product for managing a storage system, comprising:
one or more computer-readable storage media; and
program instructions stored on the one or more computer-readable storage media to perform operations comprising:
calculating a source validation check for a set of storage blocks sent from a source device to a target storage device;
determining, after the set of storage blocks are written to the target storage device, a sum validation check for the set of storage blocks written to the target storage device;
comparing the source validation check to the sum validation check; and
responsive to the source validation check differing from the sum validation check, implementing an error recovery procedure on the storage system.

13. The computer program product of claim 12, wherein the source validation check is calculated in response to determining that a threshold data transfer size for the set of storage blocks sent from the source device to the target storage device has been reached.

14. The computer program product of claim 12, wherein the operations further comprise:
determining a block validation check for each block of the set of storage blocks written to the target storage device,
wherein the sum validation check is based on the block validation checks for the set of storage blocks written to the target storage device.

15. The computer program product of claim 12, wherein implementing the error recovery procedure on the storage system further comprises:
reading the set of storage blocks to determine if the sum validation check is valid; and
responsive to determining that the sum validation check is invalid, reporting a failure to the source device.

16. The computer program product of claim 12, wherein the source device is a storage controller, and the target storage device is a storage disk.

17. The computer program product of claim 12, wherein the source device is a storage device, and the target storage device is a copy of data written to the source device.

18. The computer program product of claim 17, wherein the copy of the data written to the source device is selected from the group consisting of: a point-in-time copy, a synchronous remote copy, and an asynchronous remote copy.

19. The computer program product of claim 12, wherein the source validation check and the sum validation check are selected from the group consisting of: a longitudinal redundancy check (LRC), a cyclic redundancy check (CRC), and cryptographic hash functions.

20. A computer system for managing a storage system, comprising:
a processor set;
one or more computer-readable storage media; and
program instructions stored on the one or more computer-readable storage media to cause the processor set to perform operations comprising:
calculating a source validation check for a set of storage blocks sent from a source device to a target storage device;
determining, after the set of storage blocks are written to the target storage device, a sum validation check for the set of storage blocks written to the target storage device;
comparing the source validation check to the sum validation check; and
responsive to the source validation check differing from the sum validation check, implementing an error recovery procedure on the storage system.
